(19) United States
(12) Patent Application Publication
(10) Pub. No.: US 2013/0309533 A1
(43) Pub. Date: Nov. 21, 2013

(54) ELECTRIC STORAGE DEVICE, AND METHOD FOR PRODUCING THE SAME

(71) Applicant: GS YUASA INTERNATIONAL, LTD., KYOTO-SHI (JP)

(72) Inventor: JUN NAKAMURA, KYOTO-SHI (JP)

(21) Appl. No.: 13/893,206

(22) Filed: May 13, 2013

(30) Foreign Application Priority Data
May 16, 2012 (JP) 2012-112433

(51) Int. Cl. H01M 10/04; H01G 11/26; H01M 2/02

(52) U.S. Cl. CPC H01M 10/0431; H01M 2/02; H01G 11/26
USPC 429/94; 29/623.1; 29/25.41; 361/502

(57) ABSTRACT

An electric storage device according to the present invention is provided with a flat electrode assembly in which a positive electrode plate and a negative electrode plate are wound while being isolated from each other, and which includes a pair of folded-back portions opposed to each other with a center line therebetween and a flat portion positioned between the pair of folded-back portions; and a case for housing the electrode assembly, the case including, on an inner surface thereof, a raised portion having direct or indirect contact externally with a boundary region between one of the pair of folded-back portions and the flat portion of the electrode assembly, wherein a maximum external length of the folded-back portion in a direction orthogonal to the flat portion is greater than an external length of the boundary region in a direction orthogonal to the flat portion at a position thereof with which the raised portion has contact.

### CROSS-REFERENCE TO RELATED APPLICATION

This application is based upon and claims the benefit of priority from the prior Japanese Patent Application No. 2012-112433 dated May 16, 2012, the entire contents of which are incorporated herein by reference.

### FIELD OF THE INVENTION

The present invention relates to an electric storage device and a method for manufacturing the electric storage device.

### DESCRIPTION OF THE RELATED ART

Conventionally, there has been provided a rechargeable winding-type electric storage device as a power source of various types of equipment. This type of electric storage device is provided with a flat electrode assembly including a positive electrode plate and a negative electrode plate wound while being isolated from each other, a case for housing the electrode assembly, and a pair of external terminals disposed outside the case (see, for example, Patent Literature 1 (Japanese Patent Laid-Open No. 2007-103263) and Patent Literature 2 (Japanese Patent Laid-Open No. 2011-165515)).

The positive electrode plate of the electrode assembly is electrically connected to one of the pair of external terminals. On the other hand, the negative electrode plate of the electrode assembly is electrically connected to the other one of the pair of external terminals. Thus, the electric storage device is configured so as to charge and discharge the electrode assembly through the positive-electrode and negative-electrode external terminals.

Incidentally, this type of electric storage device may in some cases be mounted as a power supply on apparatuses that cause vibrations (e.g., various apparatuses, such as hybrid electric vehicles (HEVs), electric vehicles (EVs), electric motorcycles, aircraft, and marine vessels). In this case, the electrode assembly receives the vibration of the apparatus and tends to become displaced (fluctuated) within the case. Consequently, the electrode assembly may interfere with the case along with the displacement (swaying) of the electrode assembly, or twisting or bending may work on the electrode assembly. As a result, the electrode assembly may become damaged and degrade in performance in a conventional electric storage device when the device is used in a vibrational environment.

### SUMMARY OF THE INVENTION

The following presents a simplified summary of the invention disclosed herein in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

An object of the present invention is to provide an electric storage device capable of preventing an electrode assembly from becoming displaced due to influences of vibration and thus damaged, and a method for manufacturing the electric storage device.

The electric storage device according to the present invention is provided with a flat electrode assembly in which a positive electrode plate and a negative electrode plate are wound while being isolated from each other, and which includes a pair of folded-back portions opposed to each other with a center line of the electrode assembly therebetween and a flat portion positioned between the pair of folded-back portions; and a case for housing the electrode assembly, the case including, on an inner surface thereof, a raised portion having direct or indirect contact externally with a boundary region between one of the pair of folded-back portions and the flat portion of the electrode assembly, wherein a maximum external length of the folded-back portion in a direction orthogonal to the flat portion is greater than an external length of the boundary region in a direction orthogonal to the flat portion at a position thereof with which the raised portion has contact.

A method for manufacturing an electric storage device according to the present invention includes an electrode assembly housing step of housing a flat electrode assembly in which a positive electrode plate and a negative electrode plate are wound while being isolated from each other, and which includes a pair of folded-back portions opposed to each other with a center line of the electrode assembly therebetween and a flat portion positioned between the pair of folded-back portions; and a raised portion formation step of forming, on an inner surface of the case, a raised portion having direct or indirect contact externally with a boundary region between one of the pair of folded-back portions and the flat portion of the electrode assembly.

### BRIEF DESCRIPTION OF THE DRAWINGS

The foregoing and other features of the present invention will become apparent from the following description and drawings of an illustrative embodiment of the invention in which:

FIG. 1 is an overall perspective view of an electric storage device (battery cell) according to one embodiment of the present invention;

FIG. 2 is a cross-sectional view of the electric storage device (battery cell) according to the embodiment;

FIG. 3 is another cross-sectional view of the electric storage device (battery cell) according to the embodiment;

FIG. 4 is an overall perspective view of an electric storage device (battery cell) according to another embodiment of the present invention;

FIG. 5 is a cross-sectional view of the electric storage device (battery cell) illustrated in FIG. 4;

FIG. 6 is a cross-sectional view of an electric storage device (battery cell) according to another embodiment of the present invention; and

FIG. 7 is a cross-sectional view of an electric storage device (battery cell) according to yet another embodiment of the present invention.

### DETAILED DESCRIPTION OF THE PREFERRED EMBODIMENTS

An electric storage device according to the present invention is provided with a flat electrode assembly in which a positive electrode plate and a negative electrode plate are wound while being isolated from each other, and which includes a pair of folded-back portions opposed to each other with a center line of the electrode assembly therebetween and a flat portion positioned between the pair of folded-back portions; and a case for housing the electrode assembly, the case including, on an inner surface thereof, a raised portion having direct or indirect contact externally with a boundary region between one of the pair of folded-back portions and the flat portion of the electrode assembly, wherein a maximum external length of the folded-back portion in a direction orthogonal to the flat portion is greater than an external length of the boundary region in a direction orthogonal to the flat portion at a position thereof with which the raised portion has contact.

According to the electric storage device configured as described above, the folded-back portion catches on the raised portion of the case, thereby constraining the displacement (swaying) of the electrode assembly. By way of more specific description, the folded-back portions are formed as the result of the positive electrode plate and the negative electrode plate isolated from each other by being folded back (changed in direction). Consequently, the positive electrode plate and the negative electrode plate of each folded-back portion comparatively densely overlap with each other. Thus, each folded-back portion is less likely to deform (bend) than the flat portion. Accordingly, if the electrode assembly is caused to become displaced in a direction toward the flat portion from the folded-back portion, the folded-back portion goes into a state of being caught on the raised portion without climbing thereover. The electrode assembly is therefore prevented from displacement (swaying) inside the case, thereby preventing the electrode assembly from becoming damaged.

In one aspect of the present invention, the case may include a recessed portion on an outer surface thereof, and the raised portion may be formed along with the formation of the recessed portion. This way of configuration allows the raised portion to be formed simultaneously with the recessed portion. Consequently, the raised portion needs not be a separate member, thereby enabling costs to be reduced and a manufacturing process to be simplified.

In another aspect of the present invention, the raised portion may be formed so as to extend in a same direction as the center line of the electrode assembly. This way of configuration allows the raised portion to have contact with the boundary region over wide areas thereof. Consequently, the electrode assembly is put under restraint at many places thereof, thereby preventing the electrode assembly from becoming displaced (swaying). In addition, strength of the case is increased as the result of the raised portion structured as described above being formed on an inner surface of the case. Thus, the case is prevented from becoming swollen due to an increase in internal pressure caused by charge and discharge.

In yet another aspect of the present invention, the electric storage device may be further provided with a current collector fixed onto the inner surface of the case to support the electrode assembly, and the raised portion may be formed in positional correspondence with the boundary region between one of the pair of folded-back portions on a side on which the current collector is fixed, and the flat portion. This way of configuration allows the raised portion of the case to have contact with the boundary region on the side on which the current collector is fixed to the case. Consequently, the electrode assembly and the current collector are prevented from swaying. Thus, not only the electrode assembly but also the current collector are prevented from becoming damaged.

In one aspect of the present invention, a top portion of the folded-back portion continuous to the boundary region with which the raised portion is in contact may have direct or indirect contact with an inner surface of the case. This way of configuration prevents the electrode assembly from becoming displaced in a direction from the folded-back portion toward the flat portion by the contact of the raised portion with the boundary region (catching of the raised portion on the folded-back portion). In addition, as the result of the top portion of the folded-back portion having direct or indirect contact with the case, the electrode assembly is prevented from becoming displaced in a direction from the flat portion toward the folded-back portion (displacement in a direction opposite to the direction of displacement constrained by the raised portion).

In another aspect of the present invention, the raised portion may have direct or indirect contact externally with the flat portion in the boundary region. This way of configuration constrains the swaying of the electrode assembly as a whole. More specifically, the positive electrode plate and the negative electrode plate of the flat portion tend to be stacked so as to decrease in density toward the middle of the electrode assembly. Accordingly, the positive electrode plate and the negative electrode plate of the flat portion in the boundary region are in a state of becoming more easily bent than the folded-back portion. Thus, as the result of the raised portion having contact with the flat portion in the boundary region, the raised portion goes into a state of embracing the folded-back portion. Consequently, the electrode assembly as a whole is prevented from swaying.

In this case, the raised portion may be formed in a position where a distance between the raised portion and a center of curvature of the folded-back portion along the flat portion is greater than a radius of curvature of an innermost circumference of the folded-back portion. This way of configuration allows the raised portion to fully embrace the folded-back portion of the electrode assembly. Consequently, the electrode assembly is sufficiently prevented from swaying.

In one aspect of the present invention, the raised portion may include a first raised portion formed in positional correspondence with the boundary region between one end portion of the folded-back portion and the flat portion, and a second raised portion formed in positional correspondence with the boundary region between the other end portion of the folded-back portion and the flat portion. This way of configuration allows the electrode assembly to be held between the raised portions (the first raised portion and the second raised portion) on both sides. Consequently, the electrode assembly is constrained and sufficiently prevented from swaying.

In another aspect of the present invention, the raised portion may include raised portions provided in positional correspondence respectively with the two boundary regions located between the pair of folded-back portions and the flat portion. This way of configuration prevents the electrode assembly from becoming displaced from one of the pair of folded-back portions toward the other one thereof. That is, the electrode assembly as a whole is sufficiently prevented from becoming displaced in a direction in which the pair of folded-back portions aligns.

In one aspect of the present invention, the positive electrode plate and the negative electrode plate may be densely stacked at least at a position of the boundary region corresponding in position to the raised portion. This way of configuration can effectively prevent the electrode assembly from displacement (swaying). A more concrete description will be given here. If the positive electrode plate and the negative electrode plate are densely stacked at least at a position of the boundary region corresponding in position to the raised portion, portions of the positive electrode plate and negative electrode plate located on the outer circumference side of the electrode assembly are prevented from being largely displaced inward by the presence of the positive electrode plate and the negative electrode plate densely stacked inside the electrode assembly, even if the boundary region of the electrode assembly is partially bent (displaced inward) by the contact of the raised portion. Consequently, the raised portion goes into a state of fully embracing the electrode assembly (folded-back portion). As a result, the electrode assembly is prevented from swaying inside the case.

In another aspect of the present invention, the case may be made from metal.

In yet another aspect of the present invention, the electrode assembly may be provided with a positive-electrode lead portion provided in a first end portion of the electrode assembly and a negative-electrode lead portion provided in a second end portion of the electrode assembly on the opposite side of the positive-electrode lead portion, and the raised portion may have direct or indirect contact with a part of the flat portion between the positive-electrode lead portion and the negative-electrode lead portion.

A method for manufacturing an electric storage device according to the present invention includes an electrode assembly housing step of housing a flat electrode assembly in which a positive electrode plate and a negative electrode plate are wound while being isolated from each other, and which includes a pair of folded-back portions opposed to each other with a center line of the electrode assembly therebetween and a flat portion positioned between the pair of folded-back portions; and a raised portion formation step of forming, on an inner surface of the case, a raised portion having direct or indirect contact externally with a boundary region between one of the pair of folded-back portions and the flat portion of the electrode assembly.

In one aspect of the present invention, the raised portion formation step may be carried out following the electrode assembly housing step.

As described above, the electric storage device according to the present invention can exhibit an excellent advantageous effect of being able to prevent the electrode assembly from becoming displaced due to effects of vibration and thus damaged.

Hereinafter, one embodiment of the electric storage device according to the present invention will be described with reference to the accompanying drawings. Note that in the present embodiment, a lithium-ion battery cell (hereinafter, simply referred to as the battery cell) will be described as one example of the electric storage device.

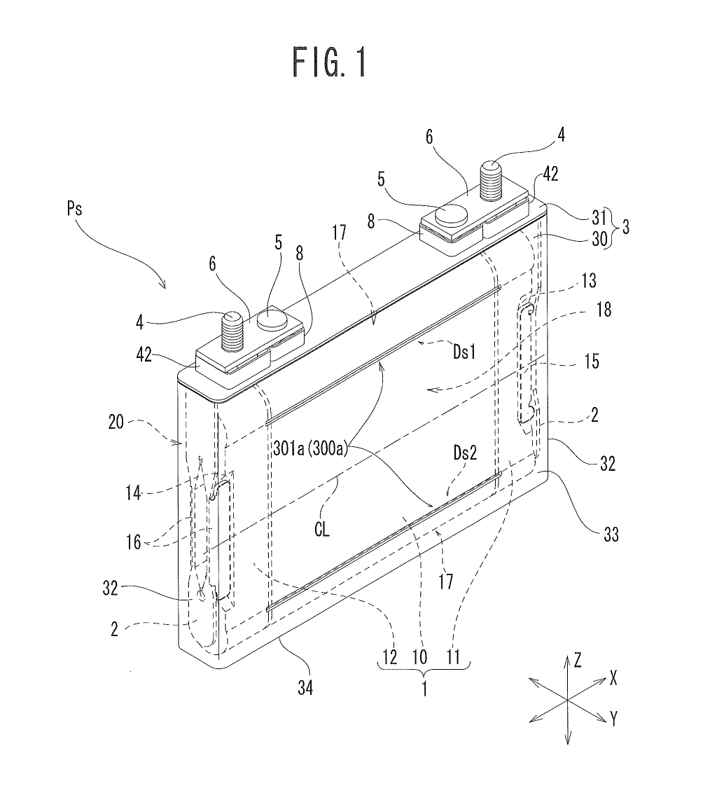

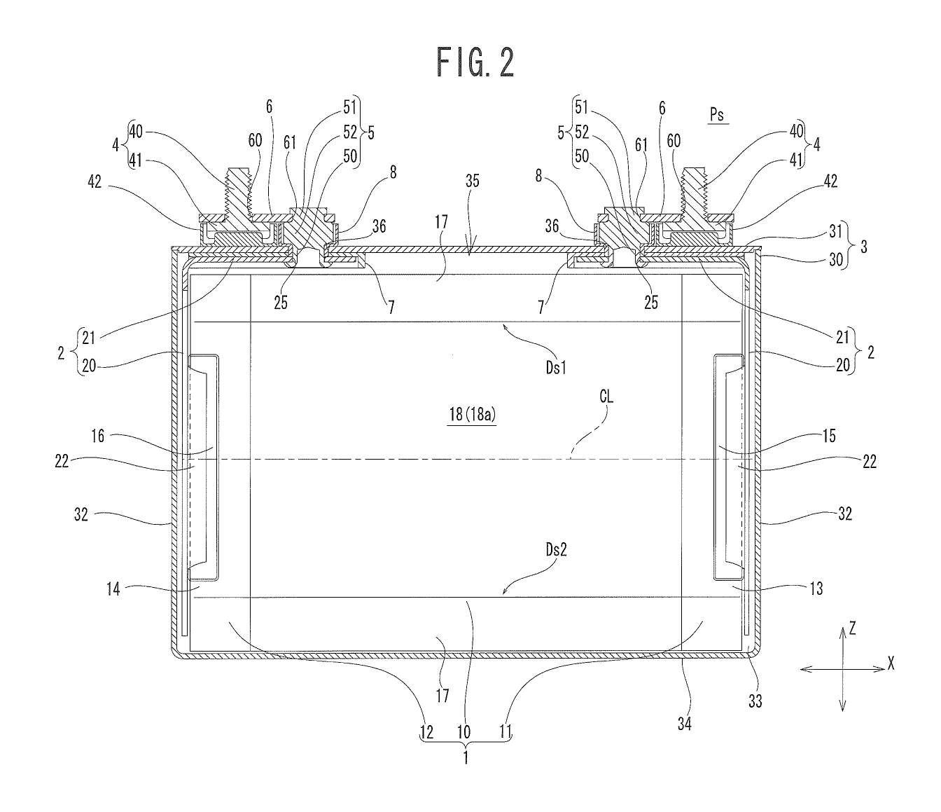

As illustrated in FIGS. 1 and 2, a battery cell Ps is provided with a flat electrode assembly 1 including a positive electrode plate 11 and a negative electrode plate 12 isolated from each other, and a case 3 for housing the electrode assembly 1. More specifically, the battery cell Ps is provided with the flat electrode assembly 1; a pair of current collectors 2 and 2 electrically connected to the positive electrode plate 11 and the negative electrode plate 12 of the electrode assembly 1 corresponding respectively in polarity to the current collectors 2 and 2; the case 3 for housing the electrode assembly 1 and the pair of current collectors 2; and a pair of external terminals 4 and 4 disposed outside the case 3.

In addition, the battery cell Ps according to the present embodiment is provided with a pair of rivets 5 and 5 connected to the pair of current collectors 2 and 2 corresponding respectively in polarity to the rivets 5 and 5; and a pair of connection strips 6 and 6 connecting between the pair of external terminals 4 and 4 corresponding respectively in polarity to the connection strips 6 and 6 and the pair of rivets 5 and 5 corresponding respectively in polarity to the connection strips 6 and 6. Accordingly, as illustrated in FIG. 2, the battery cell Ps is provided with a pair of inner gaskets 7 and 7 disposed along an inner surface of the case 3, so as to correspond respectively in location to the pair of rivets 5 and 5; and a pair of outer gaskets 8 and 8 disposed along an outer surface of the case 3, so as to correspond respectively in location to the pair of rivets 5 and 5.

In addition to the positive electrode plate 11 and the negative electrode plate 12, the electrode assembly 1 includes a separator 10 having electrical insulating properties. The separator 10, the positive electrode plate 11 and the negative electrode plate 12 are formed into belt-like shapes. The positive electrode plate 11, the negative electrode plate 12 and the separator 10 are overlapped with one another with longitudinal directions thereof aligned, and wound in the longitudinal directions. In addition, the electrode assembly 1 includes a pair of folded-back portions 17 and 17 opposed to each other with a center line CL therebetween, the center line CL extending in a first direction (X-axis direction in the figure), and a flat portion 18 positioned between the pair of folded-back portions 17 and 17.

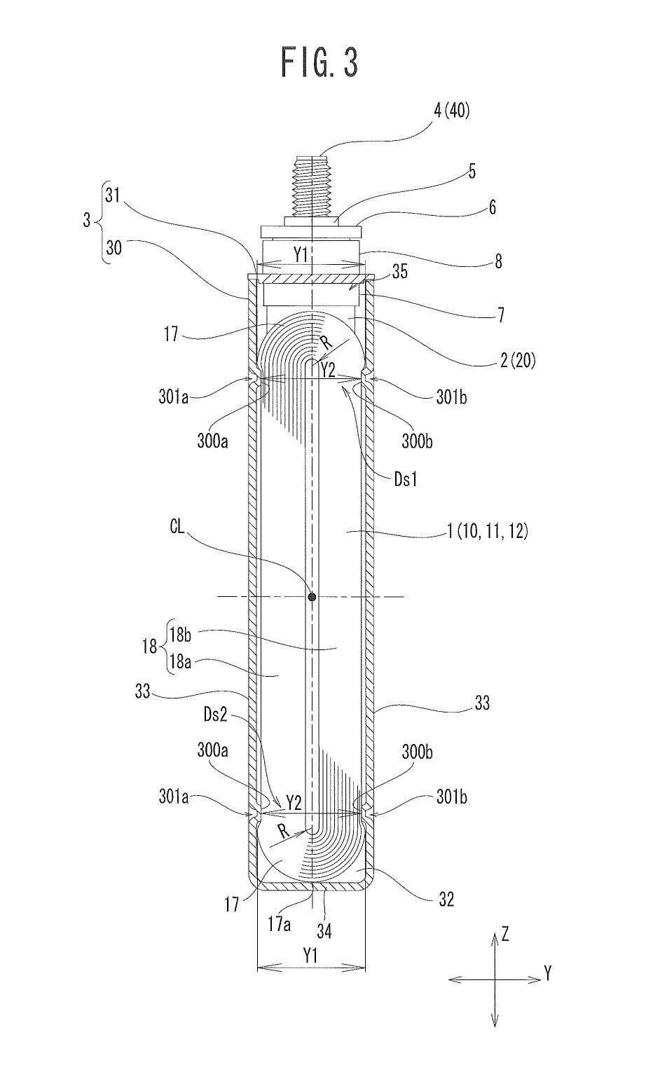

A more concrete description will be given here. As illustrated in FIG. 3, the electrode assembly 1 has a short axis in a second direction (Y-axis direction in the figure) orthogonal to the first direction, and a long axis in a third direction (Z-axis direction in the figure) orthogonal to the first and second directions. In addition, the electrode assembly 1 includes a pair of folded-back portions 17 and 17 formed on both sides thereof in the third direction (long-axis direction), and a flat portion 18 positioned between the pair of folded-back portions 17 and 17.

The pair of folded-back portions 17 and 17 are each formed into a circular-arc shape. Consequently, radii of curvature R of the positive electrode plate 11 and the negative electrode plate 12 become smaller toward inner sides thereof in a direction of lamination at the folded-back portions 17 and 17. In addition, the separator 10, the positive electrode plate 11 and the negative electrode plate 12 are densely stacked in the folded-back portions 17 and 17.

The flat portion 18 extends in the third direction between the pair of folded-back portions 17 and 17. The flat portion 18 includes a pair of stacked portions 18a and 18b disposed on both sides of the center line CL. In the flat portion 18 (pair of stacked portions 18a and 18b), the separator 10, the positive electrode plate 11 and the negative electrode plate 12 are stacked less densely than the folded-back portions 17 and 17 (the separator 10, the positive electrode plate 11 and the negative electrode plate 12).

A more concrete description will be given here. The flat portion 18 (pair of stacked portions 18a and 18b) is connected to the folded-back portions 17 and 17 where the separator 10, the positive electrode plate 11 and the negative electrode plate 12 are densely stacked. Consequently, in the flat portion 18 (pair of stacked portions 18a and 18b), the separator 10, the positive electrode plate 11 and the negative electrode plate 12 are stacked so as to decrease in density toward the middle (center line CL) of the electrode assembly from each folded-back portion 17. That is, in the flat portion 18 (pair of stacked portions 18a and 18b), the separator 10, the positive electrode plate 11 and the negative electrode plate 12 are laminate so as to increase in density toward each folded-back portion 17 from the middle (center line CL) of the electrode assembly.

Note that the separator 10, the positive electrode plate 11 and the negative electrode plate 12 of the flat portion 18 have difficulty in stretching (spreading) straight in the first and the third directions between the pair of folded-back portions 17 and 17. Actually, the separator 10, the positive electrode plate 11 and the negative electrode plate 12 become bent or undulated in at least one of the first and third directions. Accordingly, the flat portion 18 is not limited to a completely flat portion, but includes flat portions formed so as to widen into a planar shape when viewed from the second direction.

The pair of stacked portions 18a and 18b connect the end portions of the pair of folded-back portions 17 and 17 to each other. That is, the stacked portion 18a of the pair of stacked portions 18a and 18b connects first end portions of the pair of folded-back portions 17 and 17 to each other. Likewise, the stacked portion 18b of the pair of stacked portions 18a and 18b connects second end portions of the pair of folded-back portions 17 and 17 to each other. Consequently, the pair of stacked portions 18a and 18b are disposed side by side in the second direction, thus forming, between the pair of folded-back portions 17 and 17, the flat portion 18 in which the positive electrode plate 11 and the negative electrode plate 12 are alternately stacked with the separator 10 held therebetween.

Referring back to FIG. 2, the electrode assembly 1 includes a positive-electrode lead portion 13 in which only the positive electrode plate 11 is present, and a negative-electrode lead portion 14 in which only the negative electrode plate 12 is present. More specifically, the electrode assembly 1 includes a second end portion in the first direction on the opposite side of a first end portion. In addition, the positive electrode plate 11 and the negative electrode plate 12 are overlapped while being displaced from each other in a direction orthogonal to the longitudinal directions thereof. Consequently, in the electrode assembly 1, the positive-electrode lead portion 13 is formed in the first end portion and the negative-electrode lead portion 14 is formed in the second end portion.

As described above, the electrode assembly 1 according to the present embodiment is formed into a flat shape. The positive-electrode lead portion 13 and the negative-electrode lead portion 14 are therefore formed so as to extend along the flat portion 18 (third direction). Accordingly, the battery cell Ps is provided with a positive-electrode clip member 15 for bundling the positive-electrode lead portion 13 and a negative-electrode clip member 16 for bundling the negative-electrode lead portion 14.

One current collector (hereinafter, referred to as the positive-electrode current collector) 2 is formed by bending a metal plate. The positive-electrode current collector 2 includes a first end portion and a second end portion. The first end portion of the positive-electrode current collector 2 is fixed to an inner surface of the case 3. On the other hand, the second end portion of the positive-electrode current collector 2 is connected to the electrode assembly 1 in a state of extending along the flat portion 18 thereof.

A more concrete description will be given here. The positive-electrode current collector 2 is provided with a first connecting portion (hereinafter, referred to as the positive-electrode first connecting piece) 20 located along the third direction, and a second connecting portion (hereinafter, referred to as the positive-electrode second connecting piece) 21 extending from the positive-electrode first connecting piece 20.

The positive-electrode first connecting piece 20 includes a first end portion connected to the positive-electrode second connecting piece 21, and a second end portion on the opposite side of the first end portion. The positive-electrode first connecting piece 20 is connected to the positive-electrode lead portion 13. In the present embodiment, the positive-electrode first connecting piece 20 is provided with a connecting piece (hereinafter, referred to as the positive-electrode connecting piece) 22 extended in the first direction between the first end portion and the second end portion. The positive-electrode connecting piece 22 is inserted into an end portion of the electrode assembly 1 and welded to the positive-electrode clip member 15 that bundles the positive-electrode lead portion 13.

The positive-electrode second connecting piece 21 is fixed to the case 3 and electrically connected to the external terminal (positive-electrode external terminal to be described later) 4. The positive-electrode second connecting piece 21 is formed so as to be longitudinal in the first direction. A through-hole 25 for a rivet 5 to be inserted therethrough is provided in the positive-electrode second connecting piece 21.

The other current collector (hereinafter, referred to as the negative-electrode current collector) 2 is common in basic form to the positive-electrode current collector 2. Accordingly, the above description concerning the positive-electrode current collector 2 serves as an explanatory text of the negative-electrode current collector 2 when the “positive-electrode” is alternatively read as the “negative-electrode” in the description. Thus, the explanatory text concerning the positive-electrode current collector 2 is substituted for the description of the negative-electrode current collector 2.

As illustrated in FIG. 3, the case 3 includes, on inner surfaces thereof, raised portions 300a and 300b having contact with boundary regions Ds1 and Ds2 between the folded-back portions 17 and the flat portion 18 of the electrode assembly 1.

A more concrete description will be given here. As illustrated in FIGS. 2 and 3, the case 3 is provided with a case body 30 and a cover plate 31. The case body 30 includes a pair of first wall portions 32 and 32 each of which includes a first end portion and a second end portion on the opposite side thereof, and which are opposed to each other at an interval in the first direction, a pair of second wall portions 33 and 33 each of which includes a first end portion and a second end portion on the opposite side thereof, and which are opposed to each other at an interval in the second direction between the pair of first wall portions 32 and 32, and a bottom portion 34 which closes a region surrounded by the first end portions of the pair of first wall portions 32 and 32 and the first end portions of the pair of second wall portions 33 and 33. In the case body 30, an opening 35 corresponding in position to the bottom portion 34 is formed in a region surrounded by the second end portions of the pair of first wall portions 32 and 32 and the second end portions of the pair of second wall portions 33 and 33.

The case body 30 is formed by machining a metal plate (for example, drawing, bending or the like). Consequently, the pair of first wall portions 32 and 32, the pair of second wall portions 33 and 33, and the bottom portion 34 are respectively formed into plate-like shapes. As illustrated in FIG. 3, the raised portions 300a and 300b are provided on inner surfaces of the second wall portions 33. In addition, recessed portions 301a and 301b are formed on outer surfaces (outer surfaces of the case 3) of the second wall portions 33.

In the present embodiment, the raised portions 300a and 300b are formed on the inner surfaces of the second wall portions 33 along with the formation of the recessed portions 301a and 301b. The plate-like second wall portions 33 and 33 are partially embossed (pressed), thereby plastically deforming embossed portions in a through-thickness direction. Consequently, the recessed portions 301a and 301b are formed externally on the embossed portions, and the raised portions 300a and 300b are formed internally on the embossed portions. That is, partial embossing performed on the second wall portions 33 pushes in outer surfaces of the embossed portions to an inside to form the recessed portions 301a and 301a, thus pushing out (swelling) inner surfaces of the embossed portions to the inside to form the raised portions 300a and 300b. Accordingly, the raised portions 300a and 300b and the recessed portions 301a and 301a are simultaneously formed at one time of embossing.

In the present embodiment, the raised portions 300a and 300b are formed so as to extend in the same direction as the center line CL of the electrode assembly 1, as illustrated in FIG. 1. As illustrated in FIG. 3, the raised portions 300a and 300b are provided in positions corresponding at least to the position of the boundary region Ds1 of the boundary regions Ds1 and Ds2 between the folded-back portions 17 and the flat portion 18 of the electrode assembly 1 on the first end portion (the positive-electrode second connecting piece 21 and the negative-electrode second connecting piece 21 fixed to the case 2) side of the current collectors 2 (the positive-electrode current collector 2 and the negative-electrode current collector 2). In the present embodiment, the raised portions 300a and 300b are provided in positional correspondence with the respective two boundary regions Ds1 and Ds2 located between the pair of folded-back portions 17 and the flat portion 18.

In the present embodiment, the raised portions 300a and 300b include the first raised portion 300a and the second raised portion 300b formed in positional correspondence with the boundary region Ds1 between one end portion of each folded-back portion 17 and the flat portion 18, and the first raised portion 300a and the second raised portion 300b formed in positional correspondence with the boundary region Ds2 between the other end portion of each folded-back portion 17 and the flat portion 18. That is, the raised portions 300a and 300b include the first raised portions 300a and 300a corresponding in position to the boundary regions Ds1 and Ds2 between the folded-back portions 17 and 17 and the flat portion 18, and formed on one second wall portion 33 opposed to one stacked portion 18a of the flat portion 18, and the second raised portions 300b corresponding in position to the boundary regions Ds1 and Ds2 between the folded-back portions 17 and 17 and the flat portion 18, and formed on the other second wall portion 33 opposed to the other stacked portion 18b of the flat portion 18. Accordingly, in the present embodiment, two strips of raised portions (first raised portions 300a and second raised portions 300b) are provided on the respective inner surfaces of the pair of second wall portions 33 and 33 opposed to the flat portion 18 (pair of stacked portions 18a and 18b) at an interval in the third direction.

In the present embodiment, the raised portions 300a and 300b are provided so as to have contact with the flat portion 18 in the boundary regions Ds1 and Ds2. A more concrete description will be given here. The boundary regions Ds1 and Ds2 of the electrode assembly 1 have widths in the third direction (direction in which the folded-back portions 17 and the flat portion 18 align). The boundary regions Ds1 and Ds2 therefore include parts of the folded-back portions 17 and the flat portion 18. Consequently, in the present embodiment, the raised portions 300a and 300b are arranged so as to have contact with the flat portion 18 of the boundary regions Ds1 and Ds2. The raised portions 300a and 300b are provided in positions where the distance of the raised portions 300a and 300b from the center of curvature of each folded-back portion 17 in the direction along the flat portion 18 (third direction) is greater than a radius of curvature R of the innermost circumference of the folded-back portion 17.

In the electrode assembly 1, a maximum external length Y1 of each folded-back portion 17 in the direction orthogonal to the flat portion 18 (second direction) is greater than an external length Y2 of the boundary regions Ds1 and Ds2 in the direction orthogonal to the flat portion 18 (second direction) at positions thereof with which the raised portions 300a and 300b have contact, as the result of the raised portions 300a and 300b having contact with the boundary regions Ds1 and Ds2 of the electrode assembly 1. That is, the maximum external length Y1 of each folded-back portion 17 in the direction orthogonal to the flat portion 18 (second direction) is greater than the spacing between leading ends of the raised portions 300a and 300b of the mutually-opposed pair of second wall portions 33.

A top portion 17a of the folded-back portion 17 continuous to the boundary region Ds2 with which the raised portions 300a and 300b are in contact has direct or indirect contact with an inner surface of the case 3. In the present embodiment, the top portion 17a located on an outer circumference of one of the pair of folded-back portions 17 opposed to the bottom portion 34 of the case 3 (case body 30) has indirect contact with the bottom portion 34.

Specifically, the electrode assembly 1 is housed in the case 3 in a state of being wrapped in a resin sheet or contained in a resin bag (not unillustrated) having electrical insulating properties. Consequently, the top portion 17a located on the outer circumference of the folded-back portion 17 opposed to the bottom portion 34 of the case 3 (case body 30) has indirect contact with the bottom portion 34 through the resin sheet or the resin bag. Note that the folded-back portion 17 on the opposite side is opposed to the cover plate 31 of the case 3. Since the current collectors 2 and the inner gaskets 7 are disposed on an inner surface of the cover plate 31, however, the folded-back portion 17 is arranged in noncontact with the cover plate 31.

Referring back to FIG. 2, the cover plate 31 is made of a metal plate. The cover plate 31 is welded to the case body 30 with an open region 35 thereof closed. Consequently, an internal space is air-tightly formed in the case 3. A pair of through-holes 36 and 36 (hereinafter, one of the through-holes is referred to as the positive-electrode through-hole 36 and the other one of the through-holes is referred to as the negative-electrode through-hole 36) disposed at an interval in the first direction are provided in the cover plate 31.

The external terminals 4 are connected to an electrical load or another battery cell. One external terminal (hereinafter, referred to as the positive-electrode external terminal) 4 is provided with a shaft-like terminal part 40, and a head 41 coupled with one end of the terminal part 40. The terminal part 40 is structured so that an unillustrated female-threaded member (for example, a nut) is threadably mounted on the terminal part 40. That is, a bolt terminal is adopted for the positive-electrode external terminal 4. Note that the positive-electrode external terminal 4 is prevented from co-rotation resulting from the threadable mounting of the female-threaded member by engaging the head 41 with an anti-rotation member 42 fixed onto the case 3 (cover plate 31).

The other external terminal (hereinafter, referred to as the negative-electrode external terminal) 4 is formed into the same structure as that of the positive-electrode external terminal 4. Accordingly, the above description concerning the positive-electrode external terminal 4 serves as an explanatory text of the negative-electrode external terminal 4 when the “positive-electrode” is alternatively read as the “negative-electrode” in the description. Thus, the explanatory text concerning the positive-electrode external terminal 4 is substituted for the description of the negative-electrode external terminal 4.

One rivet (hereinafter, referred to as the positive-electrode rivet) 5 is provided with a plastically-deformable (caulking-treatable) shaft-like first rivet portion 50, a plastically-deformable (caulking-treatable) shaft-like second rivet portion 51, and a body 52 for coupling the first rivet portion 50 and the second rivet portion 51. The first rivet portion 50 and the second rivet portion 51 are disposed concentrically. The body 52 is formed so as to be larger in diameter than the first rivet portion 50 and the second rivet portion 51. Note that the other rivet (hereinafter, referred to as the negative-electrode rivet) 6 is formed into the same structure as that of the positive-electrode rivet 5. Accordingly, the above description concerning the positive-electrode rivet 5 serves as an explanatory text of the negative-electrode rivet 5 when the “positive-electrode” is alternatively read as the “negative-electrode” in the description. Thus, the explanatory text concerning the positive-electrode rivet 5 is substituted here for the description of the negative-electrode rivet 5.

One connection strip (hereinafter, referred to as the positive-electrode connection strip) 6 is a reed-shaped metal plate. A pair of through-holes 60 and 61 (hereinafter, one through-hole is referred to as the first hole 60 and the other through-hole is referred to as the second hole 61) are provided in the positive-electrode connection strip 6 at an interval in a longitudinal direction. The terminal part 40 of the positive-electrode external terminal 4 is inserted through the first hole 60. The first rivet portion 50 of the positive-electrode rivet 5 is inserted through the second hole 61. Note that the other connection strip (hereinafter, referred to as the negative-electrode connection strip) 6 is formed into the same structure as that of the positive-electrode connection strip 6. Accordingly, the above description concerning the positive-electrode connection strip 6 serves as an explanatory text of the negative-electrode connection strip 6 when the “positive-electrode” is alternatively read as the “negative-electrode” in the description. Thus, the explanatory text concerning the positive-electrode connection strip 6 is substituted here for the description of the negative-electrode connection strip 6.

One inner gasket (hereinafter, referred to as the positive-electrode inner gasket) 7 is a synthetic-resin molded part having electrical insulating properties and sealing properties. The positive-electrode inner gasket 7 is sized so as to be opposable to the positive-electrode second connecting piece 21 of the positive-electrode current collector 2 as a whole. The positive-electrode inner gasket 7 is formed so that the first rivet portion 50 can be inserted therethrough. As described above, the positive-electrode inner gasket 7 is arranged along the inner surface of the cover plate 31. In addition, the positive-electrode second connecting piece 21 is arranged on the positive-electrode inner gasket 7. Consequently, the positive-electrode inner gasket 7 is provided in a state of being held between the positive-electrode current collector 2 (positive-electrode second connecting piece 21) and the cover plate 31. Note that the other inner gasket (hereinafter, referred to as the negative-electrode inner gasket) 7 is formed into the same structure as that of the positive-electrode inner gasket 7. Accordingly, the above description concerning the positive-electrode inner gasket 7 serves as an explanatory text of the negative-electrode inner gasket 7 when the “positive-electrode” is alternatively read as the “negative-electrode” in the description. Thus, the explanatory text concerning the positive-electrode inner gasket 7 is substituted here for the description of the negative-electrode inner gasket 7.

Like the positive-electrode inner gasket 7, one outer gasket (hereinafter, referred to as the positive-electrode outer gasket) 8 is a synthetic-resin molded part having electrical insulating properties and sealing properties. The positive-electrode outer gasket 8 is formed so that the body 52 of the positive-electrode rivet 5 can be contained therein, and that the first rivet portion 50 can be inserted through the positive-electrode outer gasket 8 with the body 52 contained therein. Note that the other outer gasket (hereinafter, referred to as the negative-electrode outer gasket) 8 is formed into the same structure as that of the positive-electrode outer gasket 8. Accordingly, the above description concerning the positive-electrode outer gasket 8 serves as an explanatory text of the negative-electrode outer gasket 8 when the “positive-electrode” is alternatively read as the “negative-electrode” in the description. Thus, the explanatory text concerning the positive-electrode outer gasket 8 is substituted here for the description of the negative-electrode outer gasket 8.

The first rivet portion 50 of the positive-electrode rivet 5 is serially inserted through the positive-electrode outer gasket 8, the positive-electrode through-hole 36 of the cover plate 31, the positive-electrode inner gasket 7, and the through-hole 25 of the positive-electrode second connecting piece 21. Then, a leading end portion of the first rivet portion 50 protruding inward from the positive-electrode second connecting piece 21 of the positive-electrode current collector 2 is caulking-treated. The second rivet portion 51 of the positive-electrode rivet 5 is inserted through the second hole 61 of the positive-electrode connection strip 6. Then, a leading end portion of the second rivet portion 51 protruding outward from the positive-electrode connection strip 6 is caulking-treated. Consequently, the positive-electrode rivet 5 connects the positive-electrode current collector 2 to the positive-electrode external terminal 4 through the positive-electrode connection strip 6, while fixing the positive-electrode current collector 2 onto the cover plate 31 of the case 3.

As described above, a positive electrode-side configuration and a negative electrode-side configuration are common to each other. Accordingly, the above description concerning connection of the positive-electrode current collector 2 with the positive-electrode connection strip 6 and connection of the positive-electrode connection strip 6 with the positive-electrode external terminal 4 by the positive-electrode rivet 5 serves as an explanatory text concerning connection of the negative-electrode current collector 2 with the negative-electrode connection strip 6 and connection of the negative-electrode connection strip 6 with the negative-electrode external terminal 4 by the negative-electrode rivet 5 when the “positive-electrode” is alternatively read as the “negative-electrode” in the description. Thus, the explanatory text concerning connection of the positive-electrode current collector 2 with the positive-electrode connection strip 6 and connection of the positive-electrode connection strip 6 with the positive-electrode external terminal 4 by the positive-electrode rivet 5 is substituted for the description of connection of the negative-electrode current collector 2 with the negative-electrode connection strip 6 and connection of the negative-electrode connection strip 6 with the negative-electrode external terminal 4 by the negative-electrode rivet 5.

Note that while a manufacturing process of the battery cell Ps according to the present embodiment is obvious from the shapes and structures of the electrode assembly 1 and the case 3, the manufacturing process will be described hereinafter. First, there is formed a flat electrode assembly 1 in which a positive electrode plate 11 and a negative electrode plate 12 are wound while being isolated from each other, and which includes a pair of folded-back portions 17 opposed to each other with a center line CL therebetween and a flat portion 18 positioned between the pair of folded-back portions 17 (electrode assembly formation step). In addition, there is formed a case 3 for housing the electrode assembly 1 (case formation step). Then, the battery cell Ps is manufactured by an electrode assembly housing step of housing the electrode assembly 1 in the case 3, and a raised portion formation step of forming raised portions 300a and 300b having direct or indirect contact externally with boundary regions Ds1 and Ds2 between the folded-back portions 17 and the flat portion 18 of the electrode assembly 1 on inner surfaces of the case 3.

As described above, the battery cell Ps according to the present embodiment is provided with the flat electrode assembly 1 in which the positive electrode plate 11 and the negative electrode plate 12 are wound while being isolated from each other, and which includes the pair of folded-back portions 17 and 17 opposed to each other with the center line CL therebetween and the flat portion 18 positioned between the pair of folded-back portions 17 and 17; and the case 3 for housing the electrode assembly 1. In addition, as illustrated in FIG. 3, the case 3 includes, on inner surfaces thereof, the raised portions 300a and 300b having direct or indirect contact externally with the boundary regions Ds1 and Ds 2 between the folded-back portions 17 and 17 and the flat portion 18 of the electrode assembly 1, and a maximum external length Y1 of the folded-back portions 17 in a direction orthogonal to the flat portion 18 is greater than an external length Y2 of the boundary regions Ds1 and Ds2 in a direction orthogonal to the flat portion 18 at positions thereof with which the raised portions have contact. Consequently, the folded-back portions 17 catch on the raised portions 300a and 300b of the case 3, thereby constraining the displacement (swaying) of the electrode assembly 1.

By way of more specific description, the folded-back portions 17 are formed as the result of the positive electrode plate 11 and the negative electrode plate 12 isolated from each other and being folded back (changed in direction). Consequently, the positive electrode plate 11 and the negative electrode plate 12 of each folded-back portion 17 comparatively densely overlap with each other. Thus, the folded-back portions 17 are less likely to deform (bend) than the flat portion 18. Accordingly, if the electrode assembly 1 is caused to become displaced in a direction toward the flat portion 18 from each folded-back portion 17, the folded-back portions go into a state of being caught on the raised portions 300a and 300b without climbing thereover. The electrode assembly 1 is therefore prevented from displacement (swaying), thereby preventing the electrode assembly 1 from becoming damaged.

In particular, in the present embodiment, the raised portions 300a and 300b are formed so as to extend in the same direction as the center line CL of the electrode assembly 1. Accordingly, the raised portions 300a and 300b have contact with the boundary regions Ds1 and Ds2 over wide areas thereof. Consequently, the electrode assembly 1 is sufficiently prevented from displacement (swaying). In addition, the raised portions 300a and 300b structured as described above increase the strength of the case 3. Thus, the case 3 is prevented from becoming swollen due to an increase in internal pressure caused by charge and discharge.

In addition, in the present embodiment, the case 3 is provided with the raised portions 300a and 300b corresponding in position to the boundary region Ds1 on the side on which the current collectors 2 are fixed. Accordingly, the raised portions 300a and 300b of the case 3 have contact with the boundary regions Ds1 and Ds2 on the side on which the current collectors 2 are fixed to the case 3. Consequently, the electrode assembly 1 and the current collectors 2 and 2 are prevented from swaying. Thus, not only the electrode assembly 1 but also the current collectors 2 are prevented from becoming damaged.

Yet additionally, in the present embodiment, the top portion 17a of the folded-back portion 17 continuous to the boundary region Ds2 with which the raised portions 300a and 300b are in contact has indirect contact with an inner surface of the case 3 (an inner surface of the bottom portion 34). Consequently, the electrode assembly 1 is prevented from displacement in a direction from the flat portion 18 toward the folded-back portions 17 (displacement in a direction opposite to the direction of displacement constrained by the raised portions 300a and 300b). That is, the battery cell Ps according to the present embodiment prevents the electrode assembly 1 from becoming displaced in the third direction inside the case 3.

In the present embodiment, the raised portions 300a and 300b have indirect contact with the flat portion 18 in the boundary regions Ds1 and Ds2. Consequently, the electrode assembly 1 is sufficiently prevented from swaying. More specifically, the positive electrode plate 11 and the negative electrode plate 12 of the flat portion 18 are stacked so as to decrease in density toward the middle (center line CL) of the electrode assembly 1. Accordingly, the positive electrode plate 11 and the negative electrode plate 12 of the flat portion 18 in the boundary regions Ds1 and Ds2 are in a state of becoming more easily bent than the folded-back portions 17. Thus, the raised portions 300a and 300b having contact with the flat portion 18 in the boundary regions Ds1 and Ds2 go into a state of embracing the folded-back portions 17 of the electrode assembly 1. Consequently, the electrode assembly 1 as a whole is sufficiently prevented from swaying.

In particular, in the present embodiment, the raised portions 300a and 300b are formed in positions where the distance between the raised portions 300a and 300b and the center of curvature of each folded-back portion 17 in the direction along the flat portion 18 (third direction) is greater than the radius of curvature R of the innermost circumference of the folded-back portion 17. Thus, the raised portions 300a and 300b go into a state of fully embracing the folded-back portions 17 of the electrode assembly 1. Consequently, the electrode assembly 1 is sufficiently prevented from swaying.

In addition, in the present embodiment, the raised portions 300a and 300b include the first raised portions 300a and 300a formed in positional correspondence with the boundary region Ds1 between one end portions of the folded-back portions 17 and the flat portion 18 (one stacked portion 18a), and the second raised portions 300b and 300b formed in positional correspondence with the boundary region Ds2 between the other end portions of the folded-back portions 17 and the flat portion 18 (the other stacked portion 18b). Consequently, the electrode assembly 1 is sandwiched by the raised portions 300a and 300b on both sides (the first raised portion 300a and the second raised portion 300b). Thus, the electrode assembly 1 is prevented from not only displacement in the third direction but also displacement (swaying) in the second direction.

In addition, in the present embodiment, the raised portions 300a, 300a, 300b and 300b are provided in positional correspondence with the two boundary regions Ds1 and Ds2, respectively, located between the pair of folded-back portions 17 and 17 and the flat portion 18. Consequently, the electrode assembly 1 can be prevented from becoming displaced from one of the pair of folded-back portions 17 and 17 toward the other one thereof. Thus, the electrode assembly 1 as a whole is prevented from becoming displaced in a direction in which the pair of folded-back portions 17 aligns (third direction).

As described above, the battery cell Ps according to the present embodiment is adapted to prevent the electrode assembly 1 from swaying.

The battery cell Ps can therefore have the excellent advantageous effect of preventing the electrode assembly 1 from becoming damaged in a vibrational environment.

In addition, in the present embodiment, the case 3 includes the recessed portions 301a and 301b on the outer surfaces thereof, and the raised portions 300a and 300b are formed along with the formation of the recessed portions 301a and 301b. Consequently, the raised portions 300a and 300b need not be separate members, thereby enabling costs to be reduced and a manufacturing process to be simplified.

Note that the present invention is not limited to the above-described embodiment, and it is needless to say that modifications may be made to the embodiment as appropriate, without departing from the gist of the invention.

In the above-described embodiment, two raised portions 300a and 300b are respectively provided on the pair of second wall portions 33. The present invention is not limited to this configuration, however. For example, if the raised portions 300a and 300b extend in the first direction as in the embodiment, separate raised portions (raised strips) may be provided in positions of the inner surfaces of the second wall portions 33 not corresponding in position to the boundary regions Ds1 and Ds2.

In the above-described embodiment, the raised portions 300a and 300b of the case 3 are formed so as to extend in the same direction as the center line CL of the electrode assembly 1. The present invention is not limited to this configuration, however. For example, the raised portions 300a and 300b of the case 3 may be formed so as to have partial contact with the boundary regions Ds1 and Ds2 between the folded-back portions 17 and the flat portion 18 of the electrode assembly 1. That is, the raised portions 300a and 300b of the case 3 may be formed into a protrusion spot-like shape. If the raised portions 300a and 300b are formed into a protrusion spot-like shape, one or more than one of the raised portions 300a and 300b each may be provided for one of the boundary regions Ds1 and Ds2 each, so as to have contact with the boundary regions Ds1 and Ds2 of the electrode assembly 1 at one or more than one places thereof.

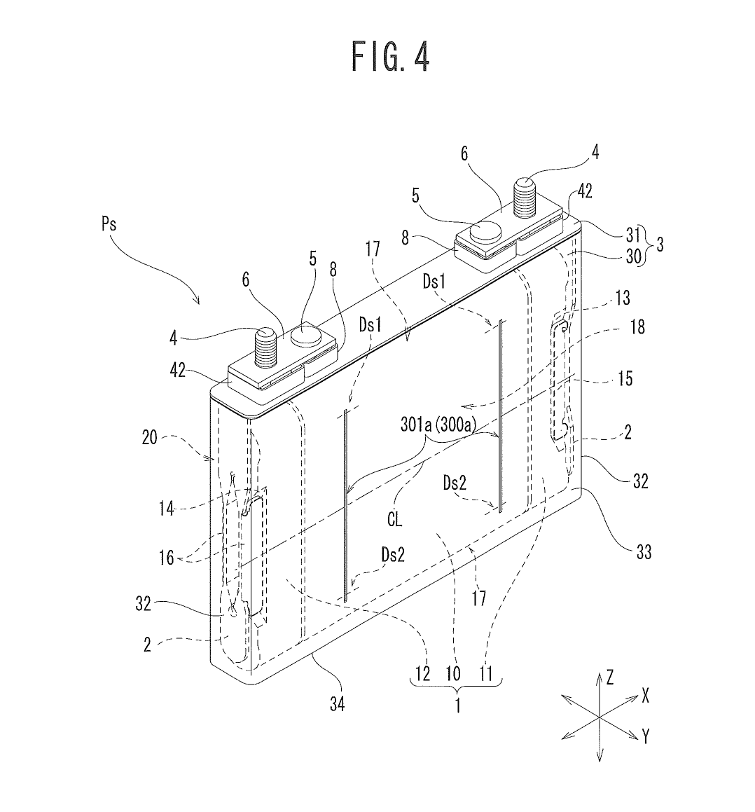

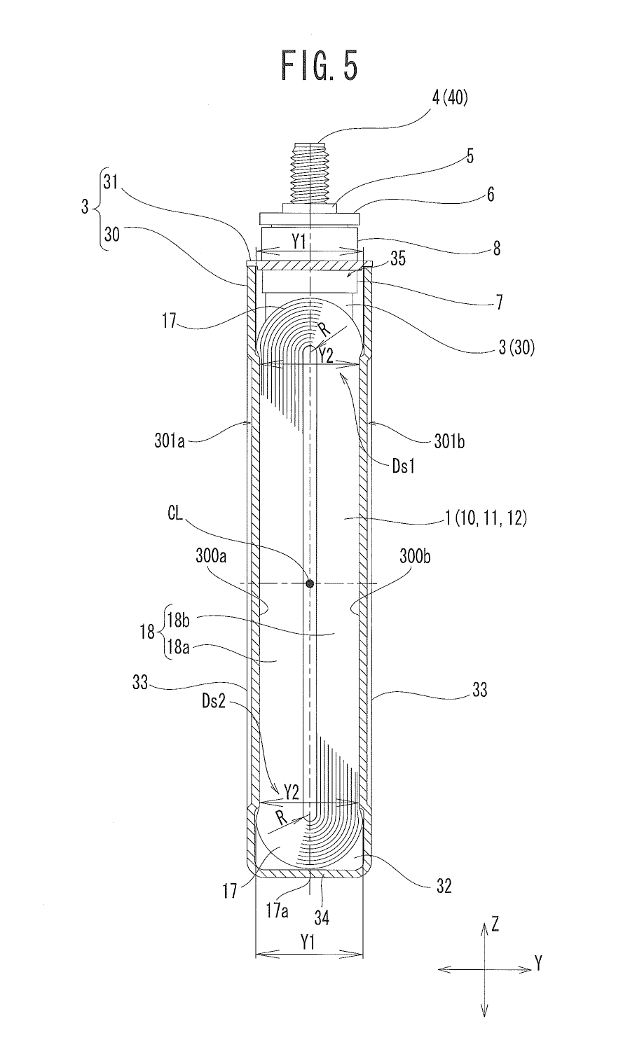

The raised portions 300a and 300b are not limited either to those extending in the first direction of the electrode assembly 1 and having partial raised portions. For example, as illustrated in FIGS. 4 and 5, the raised portions 300a and 300b may be formed so as to pass through the boundary regions Ds1 and Ds2 between the folded-back portions 17 and the flat portion 18 of the electrode assembly 1 and extend in the third direction. In this case, the raised portions 300a and 300b are preferably provided at least in a pair, so as to face the positive-electrode lead portion 13 and the negative-electrode lead portion 14 in the vicinity thereof.

As illustrated in FIG. 3, the positive electrode plate 11 and the negative electrode plate 12 of the electrode assembly 1 of the above-described embodiment are not densely stacked at positions of the boundary regions Ds1 and Ds2 corresponding in position to the raised portions 300a and 300b, with the raised portions 300a and 300b in contact with the boundary regions Ds1 and Ds2 between the folded-back portions 17 and the flat portion 18 of the electrode assembly 1. Thus, the middle of the electrode assembly 1 including the center line CL is hollow. That is, in the above-described embodiment, the pair of stacked portions 18a and 18b are disposed at an interval at the positions of the boundary regions Ds1 and Ds2 corresponding in position to the raised portions 300a and 300b. The present invention is not limited to this configuration, however. For example, the positive electrode plate 11 and the negative electrode plate 12 may be densely stacked at least at the positions of the boundary regions Ds1 and Ds2 corresponding in position to the raised portions 300a and 300b. That is, the positive electrode plate 11 and the negative electrode plate 12 may be densely stacked at least at the positions of the boundary regions Ds1 and Ds2 corresponding in position to the raised portions 300a and 300b, by disposing the pair of stacked portions 18a and 18b without interposing the hollow portion therebetween. Note that if the pair of stacked portions 18a and 18b are disposed with the hollow portion interposed therebetween, parts of the positive electrode plate 11 and the negative electrode plate 12 may be displaced to the hollow portion side, and thus producing a gap between the positive electrode plate 11 and the negative electrode plate 12.

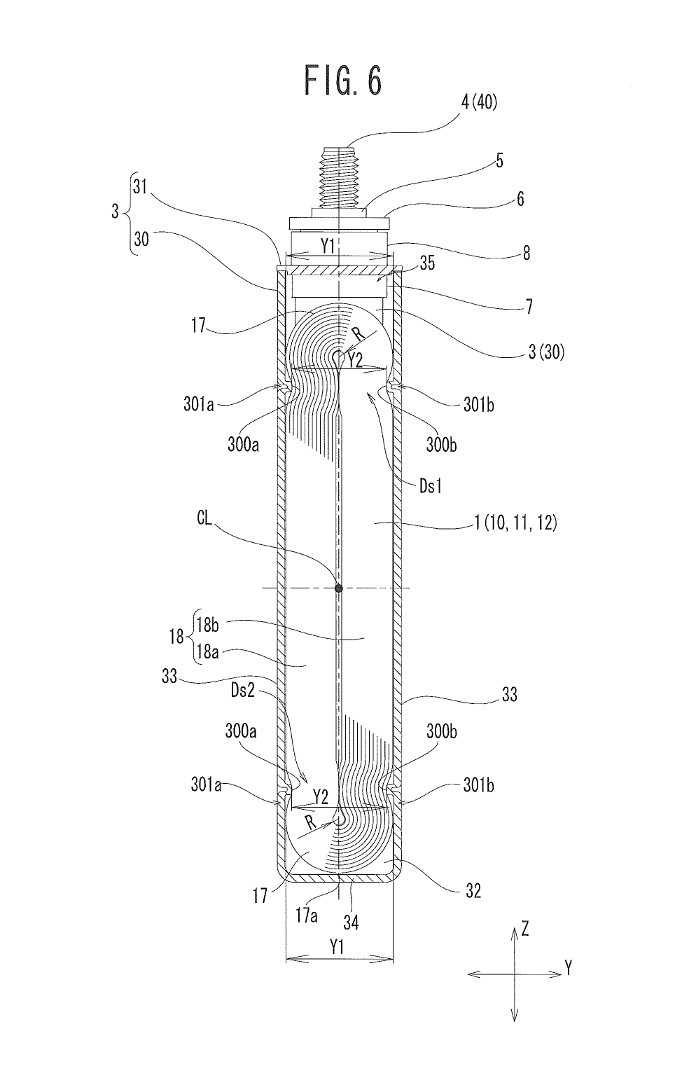

Specifically, if the raised portions 300a and 300b are formed so as to extend in the first direction (in the same direction as the center line CL of the electrode assembly 1) as in the above-described embodiment, the positive electrode plate 11 and the negative electrode plate 12 may be densely stacked at the positions of the boundary regions Ds1 and Ds2 corresponding in position to the raised portions 300a and 300b in the same way as in the above-described embodiment, as illustrated in FIG. 6. That is, the positive electrode plate 11 and the negative electrode plate 12 may be densely stacked over the entire range of the electrode assembly 1 in the second direction (direction orthogonal to the flat portion 18) at the positions of the boundary regions Ds1 and Ds2 corresponding in position to the raised portions 300a and 300b (portions of the boundary regions Ds1 and Ds2 extending in the first direction at predetermined positions in the second direction.

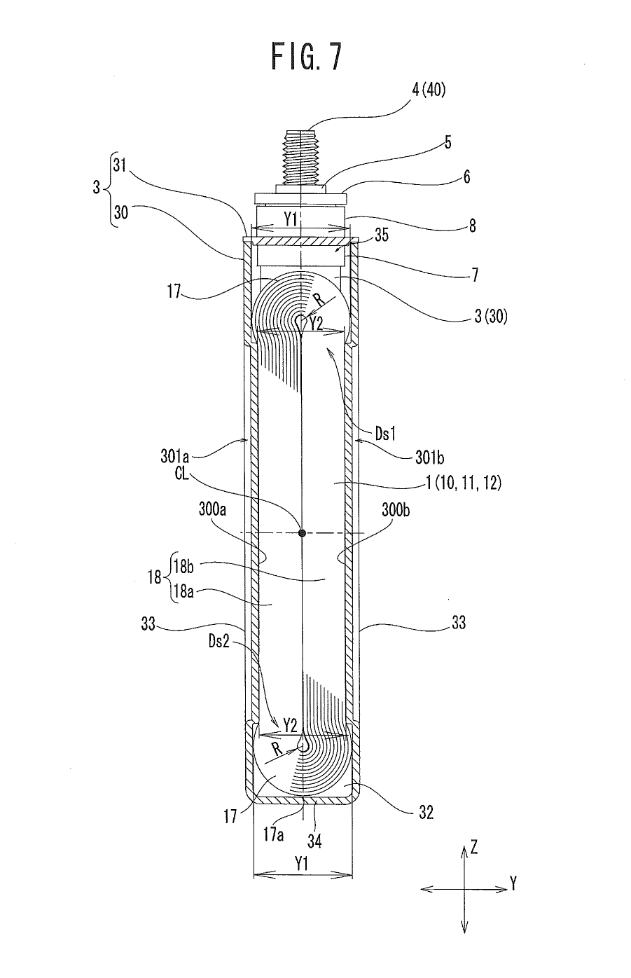

In addition, if the raised portions 300a and 300b are formed so as to extend through the boundary regions Ds1 and Ds2 between the folded-back portions 17 and the flat portion 18 of the electrode assembly 1 and extend in the third direction, the positive electrode plate 11 and the negative electrode plate 12 may be densely stacked at the positions of the boundary regions Ds1 and Ds2 corresponding in position to the raised portions 300a and 300b, as illustrated in FIG. 7. That is, the positive electrode plate 11 and the negative electrode plate 12 may be densely stacked over the entire range of the electrode assembly 1 in the second direction (direction orthogonal to the flat portion 18) at the positions of the boundary regions Ds1 and Ds2 corresponding in position to the raised portions 300a and 300b (portions of the boundary regions Ds1 and Ds2 extending in the third direction at predetermined positions in the third direction).

As the result of the positive electrode plate 11 and the negative electrode plate 12 being densely stacked at least at the positions of the boundary regions Ds1 and Ds2 corresponding in position to the raised portions 300a and 300b as described above, the positive electrode plate 11 and the negative electrode plate 12 located in the boundary regions Ds1 and Ds2 are less likely to escape inward even if the boundary regions Ds1 and Ds2 of the electrode assembly 1 become partially bent (become displaced inward) due to contact with the raised portions 300a and 300b. That is, the positive electrode plate 11 and the negative electrode plate 12 located on the outer circumference side of the electrode assembly 1 are prevented from being largely displaced inward by the presence of the positive electrode plate 11 and the negative electrode plate 12 densely stacked on the inner side of the electrode assembly 1. Consequently, the raised portions 300a and 300b go into a state of fully embracing the electrode assembly 1 (folded-back portions 17). As a result, the electrode assembly 1 is prevented from fluctuating inside the case 3.

Although not referred to in particular in the above-described embodiment, it does not matter whether or not the electrode assembly 1 includes a winding core. That is, the separator 10, the positive electrode plate 11 and the negative electrode plate 12 may be wound around a winding core or may be wound without including a winding core. This also holds true when the electric storage device (battery cell) Ps is configured according to the illustrative embodiments shown in FIGS. 6 and 7. When a winding core is adopted, it does not matter whether the winding core is solid or hollow and whether or not the winding core is rigid. If the positive electrode plate 11 and the negative electrode plate 12 are densely stacked at least at the positions of the boundary regions Ds1 and Ds2 corresponding in position to the raised portions 300a and 300b, however (see FIGS. 6 and 7), it is preferable to adopt a thin plate-like winding core or a winding core formed by shaping a resin sheet into a tubular form (a winding core to be crushed and flattened in the radial direction with the positive electrode plate 11 and the negative electrode plate 12 wound around the winding core). This way of configuration allows a solid winding core or a crushed winding core to be present in a state of being sandwiched by the pair of stacked portions 18a and 18b. Thus, no hollow portions are formed in the middle of the electrode assembly 1. Consequently, the positive electrode plate 11 and the negative electrode plate 12 are densely stacked over the entire range of the electrode assembly 1 in the second direction at least at the positions of the boundary regions Ds1 and Ds2 corresponding in position to the raised portions 300a and 300b.

In the above-described embodiment, the case 3 (second wall portions 33 and 33) is embossed (pressed) to form the recessed portions 301a and 301b on the outer surfaces of the case 3 (second wall portions 33 and 33), and concurrently with this formation of the recessed portions, the raised portions 300a and 300b are formed on the inner surfaces of the case 3. The present invention is not limited to this configuration, however. That is, the present invention is not limited to the configuration in which the recessed portions 301a and 301b are formed on the outer surfaces of the case 3. For example, the raised portions 300a and 300b may be formed separately from the case body 30 and fixed onto inner surfaces of the case body 30 (second wall portions 33).

In the above-described embodiment, the raised portions 300a and 300b of the case 3 have contact with the flat portion 18 of the boundary regions Ds1 and Ds2. The present invention is not limited to this configuration, however. For example, the raised portions 300a and 300b of the case 3 may be provided so as to have contact with the folded-back portions 17 of the boundary regions Ds1 and Ds2. Note that since the folded-back portions 17 are formed into a circular-arc planar shape, the contact of the raised portions 300a and 300b with the folded-back portions 17 is liable to be unstable. Accordingly, the raised portions 300a and 300b preferably have contact with the flat portion 18 of the boundary regions Ds1 and Ds2.

In the above-described embodiment, the battery cell Ps is provided with the pair of external terminals 4 (the positive-electrode external terminal 4 and the negative-electrode external terminal 4) which are the same in structure. The present invention is not limited to this configuration, however. For example, one of the external terminals 4 may be provided on an outer surface of the case 3, and the case 3 may be used also as the other external terminal 4. That is, one of the pair of current collectors 2 and 2 may be electrically connected to the external terminal 4, and the other one of the pair of current collectors 2 and 2 may be electrically connected to the case 3. Accordingly, the configurations of the pair of current collectors 2 and 2 and the pair of external terminals 4 and 4 can be modified in various ways.

In the above-described embodiment, the first raised portion 300a provided on the second wall portion 33 opposed to the stacked portion 18a and the second raised portion 300b provided on the second wall portion 33 opposed to the stacked portion 18b are included as the raised portions 300a and 300b. The present invention is not limited to this configuration, however. For example, the raised portion (first raised portion) 300a may be provided only on the second wall portion 33 opposed to the stacked portion 18a. In addition, the raised portion (second raised portion) 300b may be provided only on the second wall portion 33 opposed to the stacked portion 18b. Also in this case, the maximum external length Y1 of each folded-back portion 17 in the direction orthogonal to the flat portion 18 (second direction) is made greater in the electrode assembly 1 than the external length Y2 of the boundary regions Ds1 and Ds2 in the direction orthogonal to the flat portion 18 (second direction) at positions thereof with which the raised portions 300a and 300b have contact. Consequently, the folded-back portions 17 catch on the raised portions 300a and 300b, thereby preventing the electrode assembly 1 from displacement.

In addition, in the above-described embodiment, the raised portions 300a and 300b are provided in positional correspondence respectively with the boundary regions Ds1 and Ds2 in two places between the pair of folded-back portions 17 and 17 and the flat portion 18. The present invention is not limited to this configuration, however. For example, the raised portions 300a and 300b may be provided in positional correspondence with the boundary regions Ds1 and Ds2 in one place. In this case, the raised portions 300a and 300b are preferably provided in positional correspondence with the boundary region Ds1 located on the side on which the current collectors 2 are fixed to the case 3, in consideration of the displacement (swaying) of the current collectors 2.

In the above-described embodiment, the top portion 17a of the folded-back portion 17 opposed to the bottom portion 34 has contact with the bottom portion 34 of the case 3. The present invention is not limited to this configuration, however. For example, the top portion 17a of the folded-back portion 17 may not be in contact with the case 3. Alternatively, the top portion 17a of the folded-back portion 17 opposed to the cover plate 31 may have contact with the case 3 (cover plate 31) on the condition that the arrangement of the inner gaskets 7 and the like are changed as appropriate. In this case, the top portion 17a of the folded-back portion 17 opposed to the bottom portion 34 may also have contact with the bottom portion 34 of the case 3.

In the above-described embodiment, a lithium-ion battery cell is cited as one example of the electric storage device. The electric storage device is not limited to the lithium-ion battery cell, however. For example, the electric storage device may be another battery cell, such as a nickel-hydrogen battery, or a capacitor (electric double layer capacitor or the like).

What is claimed is:

1. An electric storage device comprising:
a flat electrode assembly in which a positive electrode plate and a negative electrode plate are wound while being isolated from each other, and which includes a pair of folded-back portions opposed to each other with a center line of the electrode assembly therebetween and a flat portion positioned between the pair of folded-back portions; and
a case for housing the electrode assembly, the case including, on an inner surface thereof, a raised portion having direct or indirect contact externally with a boundary region between one of the pair of folded-back portions and the flat portion of the electrode assembly,
wherein a maximum external length of the folded-back portion in a direction orthogonal to the flat portion is greater than an external length of the boundary region in a direction orthogonal to the flat portion at a position thereof with which the raised portion has contact.

2. The electric storage device according to claim 1, wherein the case includes a recessed portion on an outer surface thereof, and the raised portion is formed along with the formation of the recessed portion.

3. The electric storage device according to claim 1, wherein the raised portion is formed so as to extend in a same direction as the center line of the electrode assembly.

4. The electric storage device according to claim 1, further comprising a current collector fixed onto the inner surface of the case to support the electrode assembly, wherein the raised portion is formed in positional correspondence with the boundary region between one of the pair of folded-back portions on a side on which the current collector is fixed and the flat portion.

5. The electric storage device according to claim 1, wherein a top portion of the folded-back portion continuous to the boundary region with which the raised portion is in contact has direct or indirect contact with an inner surface of the case.

6. The electric storage device according to claim 1, wherein the raised portion has direct or indirect contact externally with the flat portion in the boundary region.

7. The electric storage device according to claim 6, wherein the raised portion is formed in a position where a distance between the raised portion and a center of curvature of the folded-back portion along the flat portion is greater than a radius of curvature of an innermost circumference of the folded-back portion.

8. The electric storage device according to claim 1, wherein the raised portion includes a first raised portion formed in positional correspondence with the boundary region between one end portion of the folded-back portion and the flat portion, and a second raised portion formed in positional correspondence with the boundary region between the other end portion of the folded-back portion and the flat portion.

9. The electric storage device according to claim 1, wherein the raised portion includes raised portions provided in positional correspondence respectively with the two boundary regions located between the pair of folded-back portions and the flat portion.

10. The electric storage device according to claim 1, wherein the positive electrode plate and the negative electrode plate are densely stacked at least at a position of the boundary region corresponding in position to the raised portion.

11. The electric storage device according to claim 1, wherein the case is made from metal.

12. The electric storage device according to claim 1, wherein:
the electrode assembly is provided with a positive-electrode lead portion provided in a first end portion of the electrode assembly and a negative-electrode lead portion provided in a second end portion of the electrode assembly on the opposite side of the first end portion; and
the raised portion has direct or indirect contact with a part of the flat portion between the positive-electrode lead portion and the negative-electrode lead portion.

13. A method for manufacturing an electric storage device comprising:
an electrode assembly housing step of housing a flat electrode assembly in which a positive electrode plate and a negative electrode plate are wound while being isolated from each other, and which includes a pair of folded-back portions opposed to each other with a center line of the electrode assembly therebetween and a flat portion positioned between the pair of folded-back portions; and
a raised portion formation step of forming, on an inner surface of the case, a raised portion having direct or indirect contact externally with a boundary region between one of the pair of folded-back portions and the flat portion of the electrode assembly.

14. The method for manufacturing an electric storage device according to claim 13, wherein the raised portion formation step is carried out following the electrode assembly housing step.
